(19) United States
(12) Patent Application Publication
(10) Pub. No.: US 2013/0193932 A1
(43) Pub. Date: Aug. 1, 2013

(54) INTERACTION OF THERMAL MANAGEMENT AND CHARGING MANAGEMENT DURING EXTERNAL CHARGING

(71) Applicant: Niklas Schalli, Munchen (DE)

(72) Inventor: Niklas Schalli, Munchen (DE)

(73) Assignee: AUDI AG, Ingolstadt (DE)

(21) Appl. No.: 13/698,522

(22) PCT Filed: May 12, 2011
(86) PCT No.: PCT/EP2011/002344

§ 371 Date: Jan. 29, 2013

(30) Foreign Application Priority Data
May 19, 2010 (DE) 10 2010 021 028.5

(51) Int. Cl. B60L 11/18

(52) U.S. Cl. CPC B60L 11/1809
USPC 320/162; 320/137

(57) ABSTRACT

Several types of power demands, including a cooling power demand for components, a heating power demands for components and comfort performance demand for a passenger compartment, can be transferred from a thermal management to a charging management, wherein the types of power demands are prioritized by the charging management in a different manner.

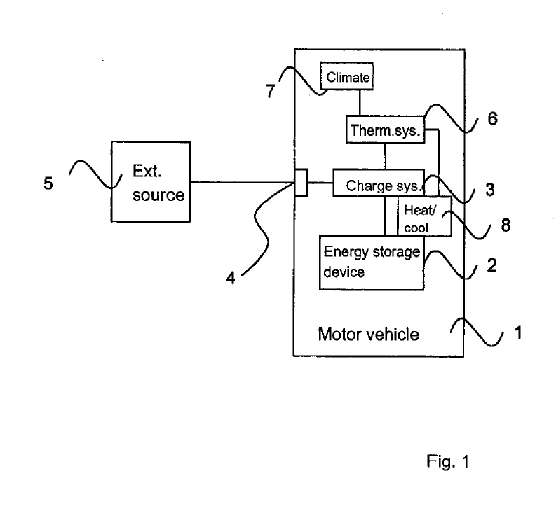

The invention relates to the interaction of thermal management and charging management when a motor vehicle is charged externally.

Plug-in hybrids and electric vehicles are known which can be charged externally. It is also known to control the temperature of the battery during the charging process.

Controlling the energy distribution during the charging process is frequently inflexible and/or overly complicated.

It is therefore the object of the present invention to flexibly and uncomplicatedly control the distribution of energy to different systems for cooling and/or heating during a charging process of a motor vehicle.

This object is attained with the inventions described in the independent claims. Advantageous embodiments are recited in the dependent claims.

The thermal management of a motor vehicle controls cooling/heating of components implemented in form of a motor, a battery, power electronics, etc., as well as cooling/heating of passenger compartment, seats, steering wheel, etc., that provide comfort. The charging management controls the energy supply of a vehicle from an external source.

In a control method for a motor vehicle, several types of power demands can be transmitted from the thermal management to the charging management, including
a cooling power demand for components,
a heating power demand for components, and
a comfort power demand for passenger comfort.
   These types of a power demand are differently prioritized by the charging management.

The invention is based on the observation that energy supply and energy distribution by the charging management can be best controlled when the charging management is aware of the power demands and the priority of the power demands of the thermal management.

Preferably, a cooling power demand for components has a higher priority than a heating power demand for components, because overheating of the components is more likely to cause damage than undercooling.

Preferably, a heating power demand for components has a higher priority than a comfort power demand for passenger comfort.

Preferably, more power is provided by the charging management for a power demand having a higher priority than for a power demand having a lower priority, when sufficient power is not available to satisfy all power demands.

In particular, a power quota is transmitted from the charging management to the thermal management which indicates how much power is supplied to the thermal management. This need not be performed specifically according to the different types of the power demand, so that the thermal management can independently apportion the parts of the quota to the individual types of power.

Alternatively or in addition, a message is transmitted from the charging management to the thermal management which indicates that a comfort power should be provided. The thermal management is hereby informed that sufficient power is available so as to also implement a comfort power.

A motor vehicle includes a thermal management system and a charging management system, wherein several types of the power demand can be transmitted from the thermal management system to the charging management system, which include
a cooling power demand for components,
a heating power demand for components, and
a comfort power demand for passenger comfort,
   wherein these three types of the power demand can be assigned different priorities by the charging management.

Additional features and advantages of the invention are described in the description of an exemplary embodiment with reference to the drawing. The figure shows a motor vehicle 1.

The motor vehicle 1 includes an energy storage device 2 in form of a traction battery. The motor vehicle 1 is in particular a plug-in hybrid or an electric vehicle having a drive which derives drive energy from the energy storage device 2.

The energy storage device 2 can be charged by a charging process and also be discharged, as needed. For this purpose, the energy storage device 2 is connected to a charging management system 3 in form of a converter with a corresponding control. The converter is in turn connected with a power contact 4 at the vehicle side, wherein a charging cable for connecting with a charging station 5 is plugged into the power contact 4.

The thermal management system 6 communicates via a CAN bus with the charging management system 3 of a climate control system 7 for controlling the climate of a passenger compartment of the motor vehicle 1 and a heating/cooling system 8 for the components converter and battery 2.

Transmittable from the thermal management system 6 to the charging management system 3 are
1. a cooling power demand for components,
2. a heating power demand for components, and
3. a comfort power demand for passenger comfort.
   The three types of demands (desired actions) are assigned different priorities. In particular, a higher priority is assigned to a cooling power demand for components than to a heating power demand for components, which has in turn a higher priority than a comfort power demand for the interior space.

Transmittable from the charging management system 3 to the thermal management system 6 are
1. a power quota which indicates how much power is made available to the thermal management, and/or
2. a message (bit: enable_interior space conditioning) which indicates that a comfort power (interior space conditioning, climate control) can be implemented.

With this type of control, the energy from the external source 5 is optimally allocated to the loads.

What is claimed is:

1-7. (canceled)

8. A control method for externally charging a motor vehicle having a thermal management controlling cooling and heating of components of the motor vehicle and a charging management controlling supply of energy to the motor vehicle from an external source, comprising:
transmitting several types of power demands from the thermal management to the charging management, with the types of power demands comprising
a cooling power demand for components,
a heating power demand for components, and
a comfort power demand for passenger comfort, and
assigning different priorities by the charging management to the several types of the power demands,
wherein a higher priority is assigned to a cooling power demand for components than to a heating power demand for components, and
a higher priority is assigned to a heating power demand for components than to a comfort power demand for passenger comfort.

9. The control method of claim 8, wherein more power is allocated by the charging management to a power demand having a higher priority than to a power demand having a lower priority.

10. The control method of claim 8, wherein a power quota is transmitted from the charging management to the thermal management which indicates an amount of power made available to the thermal management.

11. The control method of claim 8, wherein a message is transmitted from the charging management to the thermal management which indicates that a comfort power can be implemented.
